(19) United States
(12) Patent Application Publication
(10) Pub. No.: US 2017/0166344 A1
(43) Pub. Date: Jun. 15, 2017

(54) METHOD, A TRANSFER DRUM AND AN APPARATUS FOR LABELING ARTICLES

(71) Applicant: SIDEL PARTICIPATIONS S.A.S., Octeville-sur-Mer (FR)

(72) Inventors: James CARMICHAEL, Parma (IT); Mattia GIULIANI, Parma (IT)

(73) Assignee: SIDEL PARTICIPATIONS S.A.S., Octeville-sur-Mer (FR)

(21) Appl. No.: 15/354,399

(22) Filed: Nov. 17, 2016

(30) Foreign Application Priority Data
Dec. 14, 2015 (IT) EP15306999.2

(51) Int. Cl. B65C 9/22; B65C 9/18

(52) U.S. Cl. CPC B65C 9/2269; B65C 9/1819; B65C 9/2247; B65C 2009/0078

(57) ABSTRACT

There is described a labeling apparatus (1) for applying labels (2) onto a succession of articles (3) and a method of setting-up of said labeling apparatus (1) prior to the application of the labels (2). The labeling apparatus (1) comprises a transfer drum (21) for retaining on its outer surface (22) labels (2), a glue application roller (19) having an outer lateral surface (20) and being configured to apply a pattern of glue onto the labels (2). The transfer drum (21) comprises a plurality of pad assemblies (24) arranged along its outer surface (22) and pad assembly alignment means (42) configured to modify orientation and/or position of each one of the plurality of pad assemblies (24) to a respective working configuration for aligning each one of the plurality of pad assemblies (24) with respect to the outer lateral surface (20) of the glue application roller (19).

### TECHNICAL FIELD

The present invention relates to a method, a transfer drum and an apparatus for labeling articles. In particular, the present invention relates to an apparatus comprising a transfer drum having an outer lateral surface for conveying labels retained on the outer lateral surface itself from a receiving station to an application station.

### BACKGROUND ART

Labeling apparatuses for automatically attaching labels onto articles of all sort, such as receptacles, containers, vessels, bottles etc., are well known in the art and their use is widespread in the packaging industry.

One typical label type is the so-called “self-adhesive label”, which is directly wrapped around at least part of the respective article and glued thereto.

In general, in the known labeling apparatuses, prior to the application of the labels onto the respective articles, the labels are commonly conveyed by means of a transfer drum.

As known, in a labeling apparatus of the “self-adhesive label” type, which the following description will refer to without any limitative scope, each label of a succession of labels is attached onto the outer surface of one respective article. Prior to the application of the label onto the respective article glue is supplied onto the back surface of the label itself.

In these apparatuses, the articles are typically carried by a conveying carrousel along an article path so as to advance towards an application station at which one respective label is stuck onto each article. At the same time, in the known labeling apparatuses, a web of labeling material is fed from a roll-feeding unit towards a transfer drum.

In particular, the web of labeling material is advanced towards an outer lateral surface of the transfer drum. During feeding, the web of labeling material is brought into contact with a cutter of a cutting unit so as to cut the web of labeling material into labels of defined and appropriate lengths. Then each label is retained on the outer lateral surface of the transfer drum and is conveyed, by rotation of the transfer drum around its axis towards the application station.

In particular, during transfer towards the application station, the labels are retained by respective retaining sections of the outer lateral surface of the transfer drum; these retaining sections are equally spaced angularly around the axis of the transfer drum and are separated from each other by respective transition sections, along which labels fed from the roll-feeding unit slide prior to reaching the respective retaining sections. Additionally, the transfer drum comprises a plurality of pads protruding from and arranged along its outer surface, each one adapted to interact with a leading edge or a trailing edge of the labels and defining the retaining and transition sections.

Furthermore, prior to reaching the application station, each label interacts at a glue application station with a glue application unit which applies a pattern of glue onto the backside of the label so that the label can be stuck onto one respective article.

One commonly type of glue application unit comprises a rotating glue application roller tangentially cooperating with the transfer drum and adapted to contact the labels advanced by the transfer drum at the glue application station. Thereby, glue is transferred from the outer lateral surface of the glue application roller to the label. In particular, glue is transferred to the leading and trailing edges of the labels as, in use, the glue application roller contacts the labels solely at the position of the pads protruding from the outer lateral surface of the transfer drum.

In general, prior to use, in particular after a change of the transfer drum for advancing and applying a new label format, the glue application roller needs be aligned with respect to the transfer drum. The latter alignment is commonly achieved by actuating of a tilt adjustment device which, as known in the art, has a complex configuration.

A drawback of an apparatus of the kind described is felt in that the tilt adjustment device comes along with an increased complexity in machine construction and operation and an increased economical impact.

Another drawback of such an apparatus is seen in the need to provide for a very precise concentricity of the plurality of pads with respect to the glue application roller. This is typically achieved by working off of the pads or accepting small tolerances. However, in particular, in the case of larger sized transfer drums, achieving the required precision is at least difficult or even impossible to be achieved.

### DISCLOSURE OF INVENTION

It is therefore an object of the present invention to provide a label apparatus to overcome, in a straightforward and low-cost manner, the aforementioned drawbacks.

According to the present invention, there is provided a transfer drum as claimed in claim 1, a label apparatus as claimed in claim 8 and a method according to claim 15.

### BRIEF DESCRIPTION OF THE DRAWINGS

A non-limiting embodiment of the present invention will be described by way of example with reference to the accompanying drawings, in which:

FIG. 1 is a schematic top view of a labeling apparatus, with parts removed for clarity;

FIG. 2 is a perspective view showing several details, including a transfer drum of the labeling apparatus of FIG. 1, with parts removed for clarity;

FIG. 3 is a side view of several details of the labeling apparatus of FIG. 1, including the transfer drum of FIG. 2, with parts removed for clarity;

FIG. 4 is a side view of a detail of the transfer drum of FIGS. 2 and 3, with parts removed for clarity; and

FIG. 5 is a larger-scale section view along line V-V in FIG. 4.

### BEST MODES FOR CARRYING OUT THE INVENTION

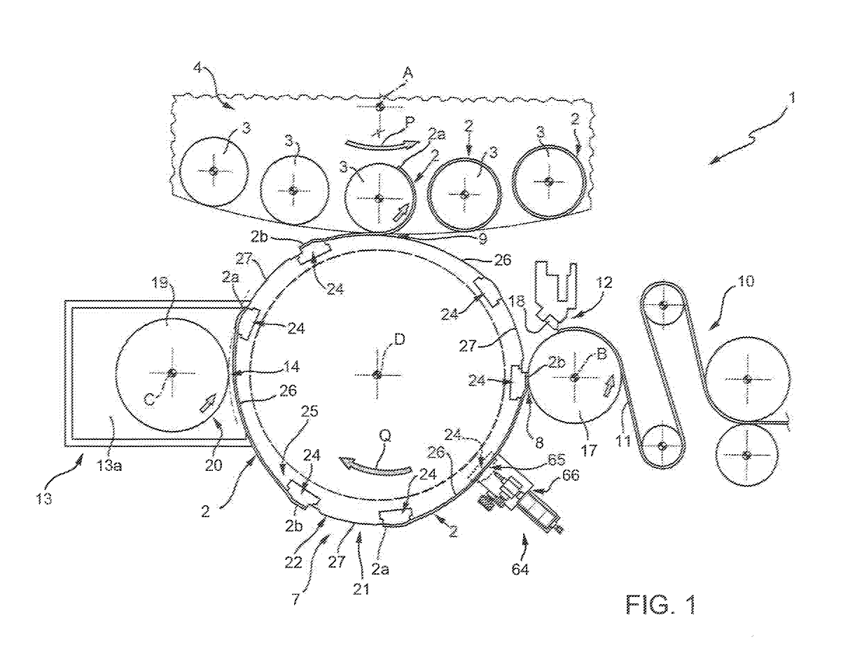

Number 1 in FIG. 1 indicates as a whole a labeling apparatus only partially shown to the extent that is necessary for the comprehension of the present invention.

Apparatus 1 is adapted to be used for handling, transferring and applying labels 2 to respective articles 3 or, more specifically, receptacles, such as bottles, as said articles 3 are advanced along an article path P.

In more detail, apparatus 1 comprises a carrousel 4 configured to support a plurality of articles 3 on its periphery and to rotate the same along path P around an axis A of the carrousel itself.

Axis A preferably extends vertically and the path P is arc-shaped and extends horizontally.

Articles 3 can be rotated as they are advanced along the path P by carrousel 4 and as labels 2 are applied to the articles 3 themselves.

Apparatus 1 further comprises:
a transfer device 7 configured to transfer a succession of labels 2 from a receiving station 8 to a label application station 9, at which labels 2 are applied onto respective receptacles 3, along a label path Q tangential to path P at label application station 9 itself;
a feeding unit 10 for feeding a web 11 of labeling material to receiving station 8;
a cutting unit 12 of known type, arranged adjacent to receiving station 8 for cutting off the succession of labels 2 from the web 11 of labeling material; and
a glue application unit 13 arranged adjacent to at least a portion of transfer device 7 and between receiving and label application station 8, 9 and configured to apply, at a glue application station 14, a given amount of glue on the back side of each label 2 advancing along the path Q prior to reaching the label application station 9.

More specifically, cutting unit 12 comprises:
a rotary cutting drum 17, having an axis B parallel to axis A, arranged adjacent to at least a portion of transfer device 7 and carrying, on its outer lateral surface, the web 11; and
a stationary cutter blade or cutter 18 carried in a fixed position on one side of rotary cutting drum 17 and proximal to receiving station 8 so as to cooperate, in use, with the rotary cutting drum 17 to cut one label 2 at a time from the web 11 of labeling material. In particular, cutting unit 12 is adapted to cut labels 2 of given lengths, each having a leading edge 2a and a trailing edge 2b.

With particular reference to FIGS. 1 to 3, glue application unit 13 comprises a glue application roller 19 having an axis C substantially parallel to axes A and B.

In particular, glue application roller 19 is configured to rotate about its axis C and has an outer cylindrical lateral surface 20, which is covered by melted glue continuously fed by a glue feeding system 13a (known as such and not further described) of glue application unit 13.

Glue application roller 19 is adapted to spread a pattern of glue onto the backside of each label 2 advancing along path Q. In particular, the pattern is provided on the side of the label 2 destined to be stuck to the surface of a respective article 3.

With reference to FIGS. 1 to 3, transfer device 7 comprises a transfer drum 21 rotatable around a central axis D, parallel to axes A, B and C and adapted to retain labels 2 on its outer lateral surface 22 during advancement of the labels 2 along path Q.

More specifically, transfer drum 21 is arranged peripherally adjacent, preferably tangential, to rotary cutting drum 17 at receiving station 8, to glue application roller 19 at glue application station 14 and to carousel 4 at label application station 9.

In particular, rotation of the transfer device 7 around axis D defines path Q of the labels 2, which follows an arc-shaped profile. More particularly, transfer drum 21 is configured to retain labels 2 on its outer lateral surface 22 and to advance these labels 2 from receiving station 8 to label application station 9 through glue application station 14 along path Q.

Transfer device 7 also comprises a base support structure 23 rotatably carrying transfer drum 21.

Furthermore, transfer drum 21 comprises a plurality of pad assemblies 24, in the specific example six, mounted along a peripheral portion 25 of transfer drum 21. In particular, pad assemblies 24 and the sections of the peripheral portion 25 not occupied by pad assemblies 24 define together the outer lateral surface 22 of transfer drum 21.

In particular, each pad assembly 24 is adapted to interact with a respective leading edge 2a or a respective trailing edge 2b of a respective label 2 for retaining the respective label 2 on the outer lateral surface 22 of the transfer drum 21.

Additionally, transfer drum 21 presents a plurality of retaining sections 26, in the particular example three, each delimited by a pair of pad assemblies 24 and adapted to retain the labels 2 during transport along path Q, in particular from receiving station 8 to label application station 9.

Furthermore, retaining sections 26 of outer lateral surface 21 are equally spaced angularly around axis D of transfer drum 21 and are separated from each other by respective transition sections 27. In particular, each transition section 27 extends between two respective retaining sections 26. Each transition section 27 is adapted to permit one label 2 being fed from feeding unit 10 to slide prior to being retained by the respective retaining section 26.

In addition, outer lateral surface 22 of transfer drum 21 or more particularly the plurality of pad assemblies 24, retaining sections 26 and transition sections 27 comprise a plurality of suction holes 28a, 28b, 28c selectively communicating with a suction source (known as such and not shown) for retaining labels 2 on outer lateral surface 22 by means of suction.

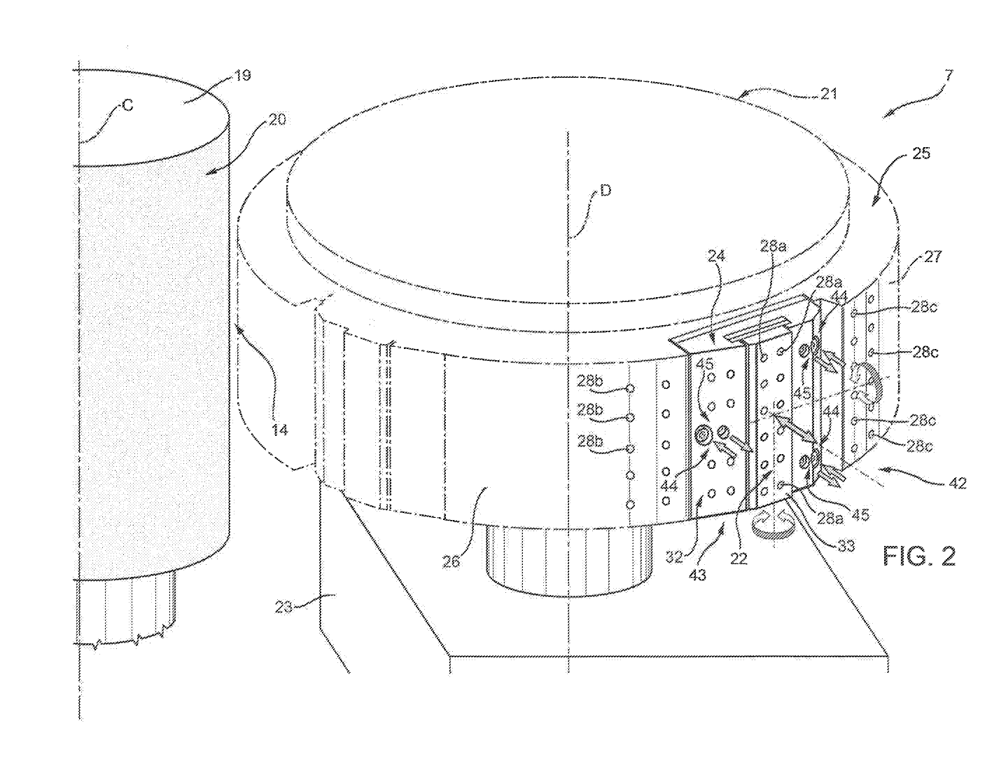

With particular reference to FIGS. 2, 3 and 5 each pad assembly 24 comprises:
a respective pad support portion 32 mounted to peripheral portion 25 of transfer drum 21; and
a respective contact pad 33 mounted to the respective pad support portion 32 and protruding away from central axis D of transfer drum 21 and, accordingly, protruding away from peripheral portion (25).

Additionally, each contact pad 33 protrudes towards outer lateral surface 20 of glue roller 19 at glue application station 14.

More specifically, each pad support portion 32 is arranged within a respective peripheral recess 34 of transfer drum 21.

Furthermore, each contact pad 33 carries a fraction of the plurality of suction holes 28a of the respective pad assembly 24. The respective suction holes 28a of each contact pad 33 are configured to be fluidically connected in a selective manner to the suction source through a respective air port 35 within transfer drum 21 and an air passage 36 of the respective pad support portion 32.

Additionally, each pad assembly 24 comprises an elastically compressible shock absorber element 37 interposed between the respective pad support portion 32 and the respective contact pad 33.

Each shock absorber element 37 is configured to compensate, in use, for a non-optimal contact between the respective contact pad 33 of the respective pad assembly 24 and outer lateral surface 20 of glue roller 19.

Each pad assembly 24 further comprises an elastically compressible sealing element 38 interposed between peripheral portion 25 of transfer drum 21 and the respective pad assembly 24, in particular between the peripheral portion 25 and the respective pad support portion 32.

Each sealing element 38 is configured to seal the respective air port 34 of transfer drum 21 and the respective air passage 35 from the outer environment. Thus, each sealing element 38 is apt to avoid, in use, loss of suction force exerted on a respective label 2 retained by the respective pad assembly 24.

With particular reference to FIGS. 2, 4 and 5, transfer drum 21 further comprises pad assembly alignment means 42 configured to modify orientation and/or position of each one of the plurality of pad assemblies 24 with respect to the central axis D of transfer drum 21.

In particular, pad assembly alignment means 42 are designed to modify orientation and/or position of each one of the plurality of pad assemblies 24 for aligning each one of the plurality of pad assemblies 24 with respect to the outer lateral surface 20 of the glue application roller 19 at glue application station 14.

More specifically, pad assembly alignment means 42 are apt to selectively modify orientation and/or position of each one of the plurality of pad assemblies 24. In particular, pad assembly alignment means 42 are configured to be activated during setting up of the labeling apparatus 1.

In use, after activation of the pad assembly alignment means 42, the respective orientations and/dr positions of each pad assembly 24 define respective working configurations of the respective pad assemblies 24.

Additionally, pad assembly alignment means 42 are configured to be deactivated during rotation of transfer drum 21 around its central axis D. Accordingly, the respective working configurations of the plurality of pad assemblies 24 are fixed during rotation of transfer drum 21 around its central axis D.

With particular reference to FIGS. 2, 4 and 5 pad assembly alignment means 42 comprise a plurality of pad assembly alignment devices 43, each one associated to one respective pad assembly 24. Furthermore, each pad assembly alignment device 43 is selectively activated independently of the other ones to modify orientation and/or position of the respective pad assembly 24.

Each pad assembly alignment device 43 comprises at least one push/pull group 44 acting on a given zone of the respective pad assembly 24 and being selectively moveable along an adjustment direction extending radially with respect to central axis D.

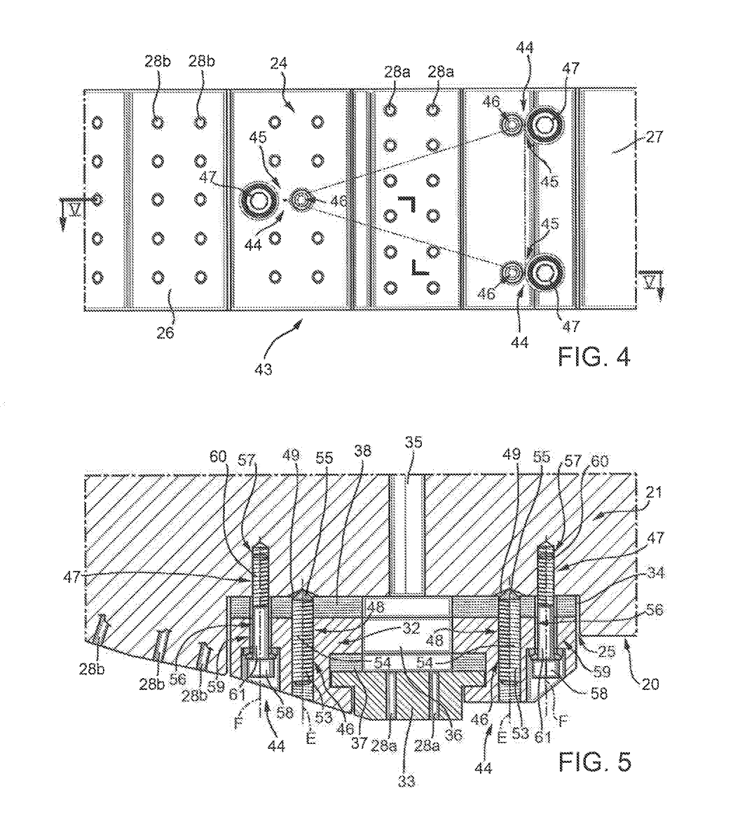

In the specific example, each pad assembly alignment device 43 comprises three push/pull groups 44, each one acting on one respective given zone 45 of the respective pad assembly 24, in particular of the respective pad support portion 32. Those three zones 45 define on the surface of the respective pad assembly 24 the vertices of a triangle (see FIG. 4).

Thus, each pad assembly alignment device 43 or more particularly the respective push/pull groups 44 are adapted to allow for modification of the orientation and/or position of the respective pad assembly 24. Additionally, each pad assembly alignment device 43, in particular the push/pull groups 44 are apt to secure the respective pad assembly 24, in particular the respective pad support portion 32 on peripheral portion 25 of transfer drum 21. Additionally, each pad assembly alignment device 43, in particular the respective push/pull groups 44 are configured to indirectly compress the respective sealing element 38 for guaranteeing the sealing effect of the respective sealing element 38.

Overall, the respective working configuration of each pad assembly 24 is obtained by cooperation of the three push/pull groups 44. The respective push/pull groups 44 of each pad assembly 23 are designed in such a manner that the respective working configuration differs with respect from the configuration prior to actuation of the respective push/pull groups 44 by a modification of only the orientation or of only the position or of the orientation and the position.

In further detail, each push/pull group 44 comprises:
a pull screw member 46 rotatable around an axis E perpendicular to axes A, B, C and D and adapted to impart a local movement of the respective pad support portion 32 into a direction away from central axis D; and
a push screw member 47 rotatable around an axis F perpendicular to axes A, B, C and D and adapted to impart a local movement of the respective pad support portion 32 into a direction towards central axis D.

With reference to FIG. 5, each pull screw member 46 is designed to extend through a first through-hole 48 of the respective pad assembly 24, in particular the respective pad support portion 32 and is apt to interact with a respective interaction surface of transfer drum 21, in particular a respective dimple 49 within peripheral portion 25 or more specifically within the respective peripheral recess 34.

Each pull screw member 46 comprises:
a drive portion 53 arranged on one end of the respective push screw member 46 and being adapted to be actuated to impart rotation of the respective pull screw member 46 around axis E;
an interaction portion 55 arranged on the other end of the respective pull screw member 46 for interacting with the respective interaction surface of transfer drum 21, in particular the respective dimple 49; and
a threaded portion 54 arranged between the relative drive portion 54 and the corresponding interaction portion 55 and being designed to interact with a threaded portion of the respective first through-hole 48 of the respective pad assembly 24.

Further, each push screw member 47 is configured to extend through a respective second through-hole 56 of the respective pad support portion 32 and into a respective threaded hole 57 within transfer drum 21.

Each push screw member 47 comprises:
a head section 58 arranged at one end of the respective push screw member 47, adapted to interact with a respective annular shoulder 59 of the respective second through-hole 56 and apt to be actuated to impart rotation of the respective push screw member 47 around axis F;
a threaded end section 60 extending from the other end of the respective push screw member 47 towards head section 58 and adapted to interact with a the respective threaded hole 57; and
a smooth shank portion 61 placed between head section 58 and threaded end section 60.

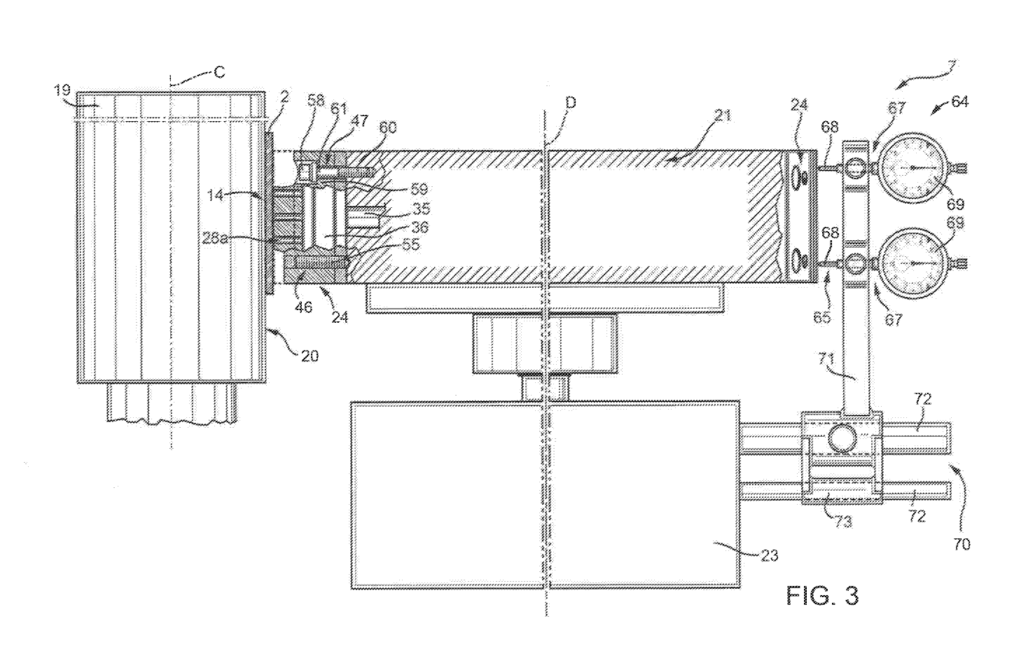

With particular reference to FIG. 3, labeling apparatus 1, in particular transfer device 7 further comprises pad alignment gauging means 64 arranged adjacent to transfer drum 21 at an alignment station 65 and being adapted to determine/verify alignment, in particular the orientation and/or position of pad assemblies 24.

Pad alignment gauging means 64 comprise a gauging assembly 66 adapted to interact at alignment station 65 with pad assemblies 24, in particular with the respective contact pads 33.

In more detail, gauging assembly 66 has at least one, in the specific example of FIG. 3 two, dial gauge elements 67 arranged parallel and adjacent to each other. In particular, one gauge element 67 is placed on top of the other.

Each gauge element 67 comprises:
a contact tip 68 configured to interact with pad assemblies 24, in particular the respective contact pads 33 for obtaining a distance and/or an angle measurement.

In particular, each contact tip 68 is adapted to move into a direction perpendicular to axis D for approaching to or withdrawing from transfer drum 21, in particular one respective pad assembly 24 position, in use, at alignment station 65.

Each gauge element 67 further comprises an amplifying unit (not shown and known as such) adapted to amplify the distance and/or angle measurement of the contact tip 68 and a display 69 indicating the result of the distance and/or angle measurement.

Pad alignment gauging means 64 further comprise a support structure 70 designed to carry the gauge assembly 66.

Support structure 70 comprises a support bar 71 arranged adjacent to transfer drum 21, in particular parallel to central axis D. Support bar 71 carries gauge assembly 66, in particular gauge elements 67 and is designed to move to or away from outer lateral surface 22 of transfer drum 21 for approaching or withdrawing, in use, gauge assembly 66 to outer lateral surface 22, in particular pad assemblies 24.

Support structure 70 further has support beams 72 mounted to base support structure 23 of transfer device 7, having an orientation perpendicular to and protruding away from axis D and a carrier element 73 slideably mounted to support beams 72 and carrying support arm 71. Carrier element 73 is also designed to be reversibly fastened on support beams 72.

Furthermore, glue application unit 13 comprises glue roller positioning means (known as such and not shown) adapted to move glue roller 19 to or away from transfer drum 21. In particular, the glue roller positioning means are configured to move glue roller 19 between an operative position at which outer lateral surface 20 of glue roller 19 is positioned to contact pad assemblies 24 at glue application station 14 and a retracted position at which glue roller 19 is withdrawn from transfer drum 21; i.e. in the retracted position the outer lateral surface 20 of glue roller 19 is distanced from pad assemblies 24 at glue application station 14.

In use, prior to the actual labeling process which is known as such and which will not be described in detail, the labeling apparatus must be set-up.

In particular, the plurality of pad assemblies 24 must be aligned with respect to outer lateral surface 20 of glue application roller 19.

Alignment of the plurality of pad assemblies 24 is achieved by modifying the orientation and/or the position of each pad assembly 24 with respect to outer lateral surface 20 at glue application station 14.

In general, modification of the orientation and/or the position of each pad assembly 24 is obtained by actuating pad assembly alignment means 42. In particular, the respective pad assembly alignment device 43 of each pad assembly 24 is actuated independently of the other pad assembly alignment devices 43.

In more detail, the orientation and/or position of each pad assembly 24 is modified by actuating the respective push/pull group 44. More particularly, an operator actuates rotation of the respective pull screw members 46 around their respective axis E and the respective push screw members 47 around axis F. Each push/pull group 44, in particular by actuation of the respective pull screw member 46 and the respective push screw member 47 locally acts on a given zone 45 of the respective pad assembly 24, more specifically on the respective pad support portion 32. Push/pull groups 44 directly act on the respective support portions 32 and, since, the respective contact pads 33 are mounted to the respective pad support portions 32 also the orientation and/or the position of the respective contact pad 33 is modified.

Overall, by cooperation of actuation all three push/pull groups 44 and eventually actuation of each push/pull group 44 more than once, a desired working configuration having the desired orientation and/or the desired position of the respective pad assembly 24 is achieved.

The alignment of the plurality of pad assemblies 24 follows in particular the hereinafter mentioned steps.

At first a first pad assembly 24 randomly chosen from the plurality of pad assemblies 24 is aligned with respect to outer lateral surface 20 of glue application roller 19 at glue application station 14.

This is done by following a series of first steps:

a: the transfer drum 21 is rotated in such a manner to position the first pad assembly 24 at glue application station 14; preferably, glue roller 19 is positioned in its retracted position;

b: then an operator determines/verifies the orientation and/or position of the first pad assembly 24, in particular by means of a space gauging device; a space gauging device can be of the feeler gauge type and, in this specific example, is adapted to determine the gap or the clearance between the first pad assembly 24, in particular the respective contact pad 33 and the outer lateral surface 20 at varying measurement positions;

c: if the operator determines that the first pad assembly 24 is not correctly aligned with respect to outer lateral surface 20 the transfer drum 21 is rotated in such a way to move the first pad assembly 24 away from glue application station 14; this is needed to provide to the operator the needed space to actuate the respective pad alignment adjusting device 43 or more specifically the respective push/pull groups 44 in a manner as described above; after actuation of the respective pad alignment adjusting device 43 the steps a and b, an if necessary also step c are repeated.

After alignment of the first pad assembly 24 the alignment of the first pad assembly 24 is taken as a reference and all other pad assemblies 24 are aligned with respect to the first pad assembly 24. Thus, usually, the pad assemblies 24 differing from the first pad assembly 24 are indirectly aligned with respect to outer lateral surface 20 of glue application roller 19 at glue application station 14.

It must, however, be understood, that alternatively all pad assemblies 24 can be aligned with respect to outer lateral surface 20 according to the steps a to c.

In the particular example described, after alignment of the first pad assembly 24 substantially two steps follow:

gauging of the pad alignment gauging means 64 with respect to the orientation and/or position of the first pad assembly 24 after alignment of the first pad assembly 24 with respect to the outer lateral surface 20 of the glue application roller 19 at the glue application station 14; and

modifying the orientation and/or the position of the other pad assemblies 24 of the plurality of pad assemblies 24 with respect to the setting of the pad alignment gauging means 64 for aligning the other pad assemblies 24.

In more detail after the series of first steps a series of second steps is followed:

d: transfer drum 21 is rotated for positioning the first pad assembly 24 at alignment station 65;

e: then gauge pad alignment gauging means 64 with respect to the first pad assembly 24 by

e′: placing gauging assembly 66, in particular dial gauge element 67 adjacent to the first pad assembly 24; and

e″: moving each contact tip 68 of each dial gauge element 67 into the direction parallel to axis D for establishing a slight contact with the first pad assembly 24, in particular the respective contact pad 33 at a respective position for determining a reference distance/angle; in particular, each contact tip 68 is moved so that each display 69 indicates a relative reference value or reference values; preferably the relative reference values of the two dial gauge elements 67 equal each other;

f: then rotate transfer drum 21 for positioning another one of the plurality of pad assemblies 24 at alignment station 65; at alignment station 65 this respective pad assembly 24, in particular the respective contact pad 33 is to be aligned with respect to both dial gauge elements 67; if the relative displays 69 of dial gauge elements 67 indicate values differing from the relative reference values orientation and/or position of the respective pad assembly 24 needs to be modified by actuation of the respective pad assembly alignment device 43 in the already described manner; the actuation of the respective pad assembly alignment device 43 is done at alignment station 65 and no prior rotation of transfer drum 21 is needed; furthermore, orientation and/or position of the respective pad assembly 24 is modified in such a manner that displays 69 of the respective dial gauge elements 67 indicate the relative reference values;

g: after alignment of the pad assembly 24 different from the first pad assembly 24, step f is repeated for the pad assemblies 24 not yet aligned until all pad assemblies 24 are aligned with respect to outer lateral surface 20.

After alignment of the plurality of pad assemblies 24 is terminated gauging assembly 66 is moved away from transfer drum 21. Then the setting up of label apparatus 1, in particular the alignment of the plurality of pad assemblies 24 has finished and label apparatus 1 is ready to begin with the labeling process.

The advantages of label apparatus 1 according to the present invention will be clear from the foregoing description.

In particular, label apparatus 1 avoids the need to provide for a complex tilt adjustment device for aligning glue application roller 19 with respect to transfer drum 21. Either no tilt adjustment device is needed or at least a tilt adjustment device having a less complex configuration can be applied. Thus, label apparatus 1 allows for a decreasing complexity of the overall machine construction.

Furthermore, the pad assembly alignment means 42, in particular the pad assembly alignment device 43 have a simple design and provide for a low-cost solution.

As well, having three push/pull groups 44 acting on three different zones 45 allows for a good control of orientation and/or position of the respective pad assemblies 24 and prevents the development of tensions within the pad assemblies 24.

Additionally, label apparatus 1 does not require working off of the pads or the acceptance of small tolerances.

As well, label apparatus 1 works equally well independently of the size of transfer drum 21.

Clearly, changes may be made to label apparatus 1 as described herein without, however, departing from the scope of protection as defined in the accompanying claims.

1. A transfer drum being adapted to retain at least one label on an outer lateral surface of the transfer drum and to convey the at least one label along a path defined by rotation of the transfer drum around a central axis of the transfer drum itself, comprising:
a plurality of pad assemblies arranged along a peripheral portion of the transfer drum, each one configured to interact with a leading or trailing edge of the at least one label for retaining the at least one label on the outer surface of the transfer drum; and
a pad assembly alignment means configured to modify the orientation and/or position of each one of the plurality of pad assemblies with respect to the central axis, wherein the respective orientation and/or the respective position of each one of the plurality of pad assemblies define a respective working configuration fixed during rotation of the transfer drum around the central axis.

2. The transfer drum according to claim 1, wherein the pad assembly alignment means comprise a plurality of pad assembly alignment devices, each one associated to one respective pad assembly and selectively activated independently of the other ones to modify the orientation and/or position of the respective pad assembly.

3. The transfer drum according to claim 2, wherein each pad assembly alignment device comprises at least one push/pull groups acting on a given zone of the respective pad assembly and selectively moveable along an adjustment direction extending radially with respect to said central axis.

4. The transfer drum according to claim 3, wherein each pad assembly alignment device comprises three push/pull groups acting on three given zones of the respective pad assembly.

5. The transfer drum according to claim 1, wherein each pad assembly comprises a respective pad support portion mounted to the peripheral portion of the transfer drum and a respective contact pad mounted to the pad support portion and protruding away from the peripheral portion of the transfer drum.

6. The transfer drum according to claim 5, wherein each pad assembly further comprises an elastically compressible shock absorber element interposed between the respective pad support portion and the respective contact pad.

7. The transfer drum according to claim 5, wherein each pad assembly further comprises an elastically compressible sealing element interposed between the peripheral portion of the transfer drum and the respective pad support portion.

8. A labeling apparatus for applying labels onto a succession of articles, comprising:
a transfer drum having a central axis and being configured to retain on an outer surface of the transfer drum itself at least one label and adapted to convey through rotation around the central axis the at least one label along a path from a receiving station to a label application station at which the at least one label is applied to one respective article; and
a glue application roller having an outer lateral surface and being mounted tangentially adjacent to the transfer drum, adapted to rotate about a rotation axis parallel to the central axis, and configured to apply a pattern of glue onto the at least one label at a glue application station interposed between the receiving station and the label application station along the path,
wherein the transfer drum comprises a plurality of pad assemblies arranged along a peripheral portion, each one adapted to interact with a leading edge or a trailing edge of the at least one label for retaining the at least one label on the outer surface of the transfer drum,
wherein the transfer drum further comprises pad assembly alignment means configured to modify the orientation and/or position of each one of the plurality of pad assemblies to a respective working configuration for aligning each one of the plurality of pad assemblies with respect to the outer lateral surface of the glue application roller at the glue application station, and
wherein each working configuration is fixed during rotation of the transfer drum around the central axis.

9. The labeling apparatus according to claim 8, wherein the pad assembly alignment means comprise a plurality of pad assembly alignment devices, each one associated to one respective pad assembly and selectively activated independently of the other ones to modify the orientation and/or position of the respective pad assembly.

10. The labeling apparatus according to claim 9, wherein each pad assembly alignment device comprises at least one push/pull groups acting on a given zone of the respective pad assembly and selectively moveable along an adjustment direction extending radially with respect to said central axis.

11. The labeling apparatus according to claim 10, wherein each pad assembly alignment device comprises three push/pull groups acting on three given zones of the respective pad assembly.

12. The labeling apparatus according to claim 8, wherein each pad assembly comprises a respective pad support portion mounted to a peripheral portion of the transfer drum and a respective contact pad mounted to the pad support portion and protruding away from the peripheral portion.

13. The labeling apparatus according to claim 12, wherein each pad assembly further comprises an elastically compressible shock absorber element interposed between the respective pad support portion and the respective contact pad.

14. The labeling apparatus according to claim 12, wherein each pad assembly further comprises an elastically compressible sealing element interposed between the peripheral portion of the transfer drum and the respective pad support portion.

15. A method for performing the set-up of a labeling apparatus according to claim 8, by comprising:
modifying the orientation and/or position of at least one pad assembly of the plurality of pad assemblies; and
aligning of said at least one pad assembly with respect to the outer lateral surface of the glue application roller at the glue application station.

16. The method according to claim 15, wherein the aligning of the at least one pad assembly of the plurality of pad assemblies with respect to the outer lateral surface of the glue application roller is determined/verified, using a space gauging device at the glue application station.

17. The method according to claim 15, wherein the aligning of a first reference pad assembly of the plurality of pad assemblies with respect to the outer lateral surface of the glue application roller is determined/verified using a space gauging device at the glue application station, and the alignment of the other pad assemblies of the plurality of pad assemblies is determined/verified at an alignment station different from the glue application station.

18. The method according to claim 17, wherein the labeling apparatus further comprises pad alignment gauging means arranged adjacent to the transfer drum at the alignment station being adapted to determine/verify alignment of the pad assemblies, and the method further comprises:
gauging of the pad alignment gauging means with respect to the orientation and/or position of the first pad assembly after aligning the first pad assembly with respect to the outer lateral surface of the glue application roller at the glue application station; and
modifying the orientation and/or the position of the other pad assemblies of the plurality of pad assemblies with respect to the setting of the pad alignment gauging means for aligning the other pad assemblies.
